(19) United States
(12) Patent Application Publication
(10) Pub. No.: US 2005/0167866 A1
(43) Pub. Date: Aug. 4, 2005

(54) Method of reducing web distortion

(76) Inventors: Michael Hennessey, South Lyon, MI (US); David Strand, Bloomfield Twp, MI (US); Barry Clark, Ortonville, MI (US)

Correspondence Address: ENERGY CONVERSION DEVICES, INC., 2956 WATERVIEW DRIVE, ROCHESTER HILLS, MI, 48309, US

(21) Appl. No.: 10/702,377

(22) Filed: Nov. 5, 2003

Related U.S. Application Data
(63) Continuation-in-part of application No. 10/600,041, filed on Jun. 20, 2003.
(63) Continuation-in-part of application No. 10/185,246, filed on Jun. 26, 2002.

(51) Int. Cl. B29D 11/00; B29C 59/02

(52) U.S. Cl. 264/1.33; 264/284; 264/348; 264/345; 264/155; 264/1.9

(57) ABSTRACT

The present invention discloses processes for an embossing thin films that uniformly anneals the full cross section of a web of polymeric material, stabilizes the hot web while the web cools, bonds/laminates the embossed area of the web to a carrier and allows a cycle time of 10 seconds or less, preferably 3 seconds or less. Embodiments of the process incorporates a thermal embossing process to bond/laminate the polymeric web to the carrier concurrent with the embossing of the polymeric web and transfers the hot embossed web from the embossing, which allows an unembossed area of web to enter the embossing zone. This process is applicable to continuous roll-to-roll as well as intermittent motion platen embossing configurations and may be used to replicate information and/or track structure for an optical memory disk on one surface of the web. Embodiments of the present invention are particularly useful for embossing thin webs having a thickness of 600 μm or less, preferably 125 μm or less.

### RELATED APPLICATION DATA

The present application is filed under 35 USC § 1.53(b) as a Continuation-in-Part of U.S. patent application Ser. No. 10/600,041 filed on Jun. 20, 2003 and a Continuation-in-Part of U.S. patent application Ser. No. 10/185,246 filed on Jun. 26, 2002, each of which is hereby incorporated herein by reference.

### FIELD OF THE INVENTION

The present invention relates to a process for embossing patterns on thin material that reduces web distortion. Further, the present invention relates to a process for embossing patterns, such as tracks for optical memory devices, with a platen mounted stamper into thin polymeric films, in which the web is bonded/laminated to a thermally and mechanically stable carrier before or during the embossing process, wherein the web and carrier are transported from the embossing zone while the web cools without damaging the embossed pattern.

### BACKGROUND OF THE INVENTION

Optical memory disks, such as CD (compact disks), CD-R, CD-RW; DVD (digital versatile disks), DVD-R, DVD-ROM, DVD-RAM, DVD+RW, DVD−RW, PD (phase change disks) and MO (magneto optical), etc., are typically manufactured by initially forming a substrate and then depositing one or more thin film layers upon the substrate. Substrates for optical memory are usually formed with a series of grooves and/or pits arranged as concentric tracks or as a continuous spiral. The grooves and pits may be used for things such as laser beam tracking, address information, timing, error correction, data, etc. Substrates used for optical disks are typically formed by injection molding, where a molten polymeric material is injected into a disk shaped mold with one surface having the patterned microstructure to be replicated. The patterned microstructure is typically provided by an exchangeable insert, commonly referred to as a stamper. The injection molding process is comprised of a series of precisely timed steps, which include closing the mold, injecting the molten polymer, providing a controlled reduction in peak injection pressure, cooling, center-hole formation, opening the mold and removing the replicated disk and associated sprue. Following the molding process, disk substrates are typically coated with one or more thin film layers. Thereafter, substrates may be coated with various insulating and/or protective layers, bonding adhesive, decorative artwork, labels, etc.

Besides lower than desired production rates, injection molding requires complex closed-loop control over numerous parameters. For example, mold and polymer temperature, press clamp force, injection profile and hold time all have competing and often-opposed influences on birefringence, flatness, and on the accuracy of the replicated features.

To speed-up the rate of manufacturing to realize embossing on thin films, a number of methods for manufacturing optical memory using continuous web processes have been proposed. These methods are built on the concept of forming a microstructure pattern on a continuous web of material by passing the web between a roller and a stamper.

To date, there have been two types of continuous web processes proposed. These processes include “in-line” and “off-line” methods. In-line continuous web processes integrate web extrusion with microstructure pattern formation in the same process, while off-line continuous web processes carry out web formation on pre-fabricated web material which is manufactured on another production line. The goal of in-line formation is to contact the web with a stamper immediately after web extrusion and while the web is still hot. Examples of in-line processes include those described in U.S. Pat. Nos. 5,137,661; 4,790,893; 5,433,897; 5,368,789; 5,281,371; 5,460,766; 5,147,592; and 5,075,060, the disclosures of which are herein incorporated by reference. The integration of web extrusion and web formation requires that a disk manufacturer not only engage in the business of producing optical disks but also in web extrusion. This makes the overall system a highly complex process, at a point in the process where it may not be desirable. Furthermore, because the disk manufacturer may not enjoy the same economies of scale that a plastic web manufacturer does, the cost per unit for disks formed with in-line processes may be higher than that for off-line processes. Thus, the present inventors propose that off-line processing not only offers the opportunity for improved throughput, reduced cost and complexity, and shorter start-up time, but for increased process flexibility as well.

A wide range of time vs. temperature combinations may be used to form microstructures in polymeric web. For example, melt-forming may be used to form microstructure in less than 5 milliseconds, while some traditional hot embossing processes may take 10's of minutes.

Web distortions, such as shrinkage and annealing related to curl, are most easily controlled at either process time extreme. For example, with a contact time less than 15 milliseconds it is possible to effectively constrain process related effects to the surface of the web. By limiting shrinkage and annealing effects to a thin surface layer, the web can resist resulting bending forces. Longer process times result in a greater effective thermal penetration depth, creating unbalanced shrinkage and annealing forces strong enough to curl and distort the web. With web thickness on the order of 0.01 inch or greater it is possible to process both sides of the web simultaneously or sequentially in order to balance distorting forces. However, as thickness is reduced below 0.005 inch, normal handling methods introduce unacceptable stretching distortions into the heated web. Complications resulting from handling hot, thin web typically lead to a process where web is heated and cooled while clamped between opposing surfaces of an essentially flat tool. An extended process time allows full depth annealing and stabilized cooling to be realized. In this way shrinkage and annealing forces may be balanced through the full cross section of web, and stretching distortions resulting from handling heated web are eliminated. While such processes are capable of providing excellent quality, cycle time is typically greater than 1 minute.

Currently there exists a need in the art for an embossing process that uniformly anneals the full cross section of polymeric web, stabilizes the hot web while it cools below T_{g}, and allows a cycle time of 10 seconds or less, preferably 3 seconds or less. The present invention overcomes deficiencies in the prior art by using a thermal embossing process to fully anneal the process web and bond/laminate the process web to a stabilizing carrier concurrent with the embossing process, which allows the embossed hot web to be removed from the embossing zone during cooling. While the embossed hot web cools, a fresh length of web is set in the embossing zone for embossing. The process of the present invention is applicable to continuous roll-to-roll as well as intermittent motion platen embossing configurations.

### SUMMARY OF THE INVENTION

Embodiments of the present invention disclose an embossing process that uniformly anneals the full cross section of polymeric web, stabilizes the hot web while it cools below T_{g}, bonds/laminates the embossed area of the web to a carrier and allows a cycle time of ten seconds or less. Embodiments of the process incorporates a thermal embossing process to bond/laminate polymeric web to the carrier concurrent with the embossing of the polymeric web and transfers the hot embossed web from the embossing zone, which then allows an unembossed area of web to enter the embossing zone. This process is applicable to continuous roll-to-roll as well as intermittent motion platen embossing configurations and may be used to replicate information and/or track structure for an optical memory disk on the surface of the web. Regardless of the application, the web and carrier are preferably stabilized, i.e. no differential movement between the web and carrier during bonding/laminating, embossing, and removal from the embossing zone. Differential movement may pull the web and/or carrier during engagement with components within the embossing zone, which may cause the microform image to become distorted. Embodiments of the present invention are particularly useful for embossing thin webs having a thickness of 600 μm or less, preferably 125 μm or less, most preferably 30 μm to 100 μm.

Embodiments of the present invention disclose processes for embossing microstructures, such as the track structure for an optical memory device, on the surface of a thin film (thickness of 600 μm or less) wherein the embossed film is cooled outside of the embossing zone which eliminates time needed to cool the web in the embossing zone, so that the time spent in the embossing zone is minimized, allowing the process to quickly and efficiently mass produce embossed thin films.

An embodiment of the present invention discloses a process for embossing microstructures into the surface of polymeric material. The process comprises providing a web of polymeric material and adapting the web of polymeric material to move into an embossing zone between a first platen and a second platen, wherein the first platen is equipped a stamper having a substantially flat surface with at least one microstructure image. A carrier is set between the second platen and the web of polymeric material. Further, the process comprises bonding/laminating the web of polymeric material to the carrier prior to or concurrent with the embossing process. The carrier may be located on the side of the web opposite the stamper, so that the web may be positioned between the stamper mounted to the first platen and the carrier. In implementations where embossing and bonding/laminating to the carrier occur concurrently, the clamping pressure produced between the first platen and second platen allows the stamper to thermally emboss the polymeric web material and bond/laminate the polymeric web material to the carrier. Preferably, the combination of pressure, heat and time fully anneals the polymeric material through the entire cross section of the polymeric material. Further, the process comprises heating the web and embossing the microstructure image on the web of polymeric material with the stamper in the embossing zone. Preferably, heating the web comprises heating the stamper to at least the glass transition temperature (Tg) of the polymeric material. More preferably, the process of heating the web further comprises heating the carrier. The carrier may be heated as a result of heat transferred through the web, a heated second platen and/or pre-heated prior to entering the embossing zone. Preferably, the bonding/laminating of the web of polymeric material to the carrier occurs concurrently with the embossing of the microstructure image on the web of polymeric material in the embossing zone. The process may further comprise transporting the web of polymeric material and carrier out of the embossing zone. The process may further comprise cooling the web of polymeric material to a temperature below the glass transition temperature and separating the web of polymeric material from the carrier after cooling. By removing the web of polymeric material and carrier out of the embossing zone immediately after the stamper separates from the web, the thermally and mechanically stable carrier transports the embossed hot web away from the embossing zone during cooling and allows a fresh, un-embossed section of web to enter the embossing zone. This creates a more time efficient process by allowing the still hot embossed web to be removed from the embossing zone without waiting for the web to cool sufficiently to withstand removal and/or further processing.

The present invention discloses several embodiments for the carrier. The embodiments of the carrier include but are not limited to a second continuous web of polymeric material moving between the process web and second platen, pre-forms of polymeric material set between the process web and second platen, carrier inserts, a re-circulating belt of polymeric material moving between the process web and second platen, segments of polymeric material set between the process web and second platen, pallets of polymeric material, re-circulating segments of polymeric material and re-circulating pallets of polymeric material. Construction materials for the carrier may be any material that meets the needs for the particular carrier embodiment. Construction materials may include metallic materials, ceramic materials, glass-like materials, composite materials or polymeric materials.

An embodiment of the present invention discloses a process for reducing polymeric web distortion by bonding/laminating the polymeric web to a thermally and mechanically stable carrier prior to or during the embossing of the web, wherein the carrier transports the embossed section of polymeric web from the embossing zone while the polymeric web cools to a temperature to allow for separation of the embossed web from the carrier.

An embodiment of the present invention discloses a process for reducing polymeric web distortion by uniformly annealing the entire cross section of the polymeric web and stabilizing the polymeric web during cooling below Tg, wherein the embossing process time is less than 10 seconds, preferably less than 3 seconds, most preferably less than 1 second.

An embodiment of the present invention discloses a process for reducing polymeric web distortion by uniformly annealing the entire cross section of the polymeric web, wherein the web is adapted to move into an embossing zone between a stamper and a carrier plate, wherein the stamper is heated.

An embodiment of the present invention discloses a process for reducing polymeric web distortion that allows the embossed hot polymeric web to be transported from an embossing zone during cooling of the hot polymeric web, wherein a carrier transports the embossed hot web from the embossing zone, allowing another section of polymeric web to enter the embossing zone, while the embossed hot web cools sufficiently to permit separation from the carrier without damaging the embossed image on the embossed polymeric web.

An embodiment of the present invention discloses a process for reducing polymeric web distortion by bonding/laminating the polymeric web to a thermally and mechanically stable carrier prior to or during the embossing of the web in the embossing zone, altering heat flow from the polymeric web into the opposing roller or platen, reducing the thermal gradient across the polymeric web and creating a more uniform temperature profile through the thickness of the polymeric web.

An embodiment of the present invention discloses a process for reducing polymeric web distortion by bonding/laminating the polymeric web to a thermally and mechanically stable carrier prior to or during the embossing of the web and creating a uniform temperature profile which results in uniform shrinkage and annealing though the entire thickness of the polymeric web.

An embodiment of the present invention discloses a process for reducing polymeric web distortion by bonding/laminating the polymeric web to a thermally and mechanically stable carrier, wherein the carrier has a uniform thermal conductivity and stabilizes the web while cooling.

An embodiment of the present invention discloses a process for reducing polymeric web distortion by bonding/laminating the polymeric web to a thermally and mechanically stable carrier prior to or during the embossing of the web, wherein the carrier comprises a continuous web of polymeric material between the process web and second platen or roller, the carrier web moving in unison with the process web.

An embodiment of the present invention discloses a process for reducing polymeric web distortion by bonding/laminating the polymeric web to a thermally and mechanically stable carrier prior to or during the embossing of the web, wherein the carrier comprises a removable carrier insert set between the process web and the second platen or roller.

An embodiment of the present invention discloses a process for reducing polymeric web distortion by bonding/laminating the polymeric web to a thermally and mechanically stable carrier prior to or during the embossing of the web, wherein the carrier comprises a removable carrier insert constructed of metal, ceramic, glass-like, or composite material.

An embodiment of the present invention discloses a process for reducing polymeric web distortion by providing mechanically stabilized controlled cooling downstream of the embossing zone which allows “full depth annealing” embossing process times of less than 10 seconds, preferably less than 3 seconds.

### BRIEF DESCRIPTION OF THE DRAWINGS

In order to assist in the understanding of the various aspects of the present invention and various embodiments thereof, reference is now made to the appended drawings, in which like reference numerals refer to like elements. The drawings are exemplary only, and should not be construed as limiting the invention.

FIG. 1 is a conceptual illustration of an embodiment of the present invention wherein a carrier is positioned between a process web and a second platen;

FIG. 2 is an illustration of an embodiment of the present invention wherein the carrier is a carrier support, wherein the carrier support moves from a payoff roll to a take up roll, wherein the rolls rotate in a counter clockwise direction;

FIG. 3 is an illustration of an embodiment of the present invention wherein the carrier is a carrier support, wherein the carrier support moves from a payoff roll to a take up roll, wherein the platens are engaged and the embossed section of the process web in bonded/laminated to the carrier material;

FIG. 4A is an illustration of an embodiment of the present invention wherein the carrier is a carrier support, wherein the carrier support is a re-circulating belt of carrier material and the process web is set to move into and out of the embossing zone between the re-circulating belt and the stamper;

FIG. 4B is an illustration of an embodiment of the present invention wherein the carrier is a carrier support, wherein the carrier support is a re-circulating belt of carrier material, wherein the platens are engaged and the embossed section of the process web in bonded/laminated to the re-circulating belt of carrier material;

FIG. 5A is an illustration of an embodiment of the present invention wherein the carrier is a removable carrier insert set between the second platen and the process web on a track;

FIG. 5B is an illustration of an embodiment of the present invention wherein the carrier is a removable carrier insert set between the second platen and the process web on a track, wherein the platens are engaged and the embossed section of the process web in bonded/laminated to the carrier insert;

FIG. 6 is a conceptual illustration of an embodiment of the present invention wherein a carrier is positioned between a process web and a second platen, wherein an insulator layer is incorporated;

FIG. 7 is a graphical illustration of the process web temperature at varying levels of thickness wherein the stamper is heated to 200° C. and the second platen is at ambient temperature, approximately 25° C.;

FIG. 8 is a graphical illustration of the process web temperature at varying levels of thickness wherein the stamper is heated to 200° C. and the second platen is heated to 50° C.;

FIG. 9 is a graphical illustration of the process web temperature at varying levels of thickness wherein the stamper is heated to 200° C. and the second platen is heated to 100° C.;

FIG. 10 is a graphical illustration of the process web temperature at the web/stamper interface and the web/carrier interface wherein the stamper is heated to 180° C. and the second platen is at ambient temperature, approximately 25° C.;

FIG. 11 is a graphical illustration of the process web temperature at varying levels of thickness wherein the stamper is heated to 180° C. and the second platen is heated to 100° C.; and

FIG. 12 is a graphical illustration of a cooling profile for each side of a web during forced convection cooling.

### DETAILED DESCRIPTION OF EMBODIMENTS OF THE INVENTION

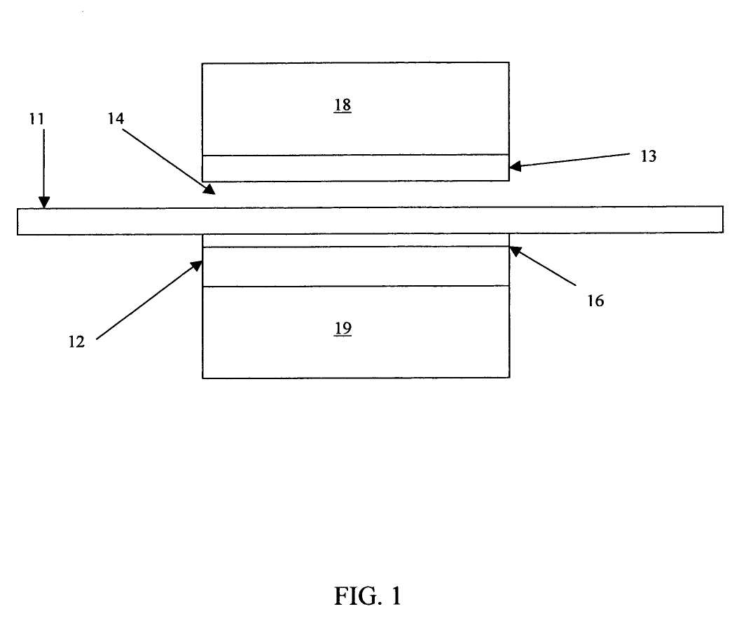

An embodiment of the present invention incorporates the bonding/laminating of a process web to a thermally and mechanically stable carrier during a thermal embossing step. Referring to FIG. 1, the carrier 12 is positioned on the side of the process web 11 opposite the embossing tooling (i.e. stamper 13). In this way a carrier 12 is positioned between the web 11 and the opposing roller or platen 19, as illustrated in FIG. 1. Further, the set up may also include an adhesion layer 16 between the web 11 and the second platen 19, wherein the adhesion layer 16 assists the web 11 in bonding/laminating to the carrier 12. The carrier 12 serves at least two purposes. First, the thermal environment created by the laminated carrier 12 alters the heat flow from the process web 11 into the opposing roller or platen 19. This reduces the thermal gradient across the web 11 and allows a more uniform temperature profile to be created through the thickness of the web 11. The uniform temperature profile results in uniform shrinkage and annealing through the thickness of the web 11, reducing curling and warp. Second, the hot web 11 is mechanically stabilized while it cools as a result of being bonded/laminated to the carrier 12. This allows stabilized, controlled cooling to continue after the web 11 exits the embossing zone 14, allowing a fresh section of process web 11 to enter the embossing zone 14 for processing.

For the purposes of this application, the word “bond(ed or ing)” is intended to describe a situation in which the process web is permanently adhered to the carrier and the word “laminate(d)” or “laminating” is intended to describe a situation in which the process web is temporarily adhered to the carrier for the processes described. When laminated to the carrier, the embossed web may be peeled or otherwise separated from the carrier. “Adhere(d)” or “adhering” is intended to encompass both “bond(ed or ing)” and “laminate(d)” or “laminating”.

Providing mechanically stabilized controlled cooling downstream of the embossing zone allows “full depth annealing” process times of less than 10 seconds. Depending on the temperature at the stamper web interface and the glass transition temperature of the process web, the process time may be less than 1 second. After the embossing of the web, the embossed web and carrier are transported from the embossing zone while the web cools. This enables another image to be embossed on a fresh, unembossed section of web to enter the embossing zone while the embossed web cools for removal and/or further processing. The unembossed section enters the web and the embossing/annealing/bonding/laminating process is repeated. Although the preferred embodiment of the present invention incorporates a process in which the temperature of the process web achieves a temperature above Tg, but below Tf, the present invention may be applied to systems in which the temperature of the web is Tf or above. For the purposes of this application, the terms “first platen” and “platen stamper” refer to the same aspect of the invention described.

The present invention discloses several embodiments of the web carrier function. For example, the carrier may be provided by a second continuous web of polymeric material, pre-forms of polymeric material, a re-circulating belt of polymeric material, segments of polymeric material, pallets of polymeric material, re-circulating segments of polymeric material, re-circulating pallets of polymeric material or carrier inserts. Likewise, the carrier may also be comprised of metallic, ceramic, glass-like materials, glass or composite materials. The ability to uniformly bond/laminate the process web to a thermally and mechanically stable carrier concurrent with the thermal embossing step is one aspect of a preferred embodiment of the present invention. Typically the process web and carrier are separated after the web cools to a point where the web may be removed from the carrier without damage to the microform image, although this is not a requirement. For example, the carrier may support the embossed web through subsequent processing steps, or be part of a permanent assembly process with the carrier a part of the final product.

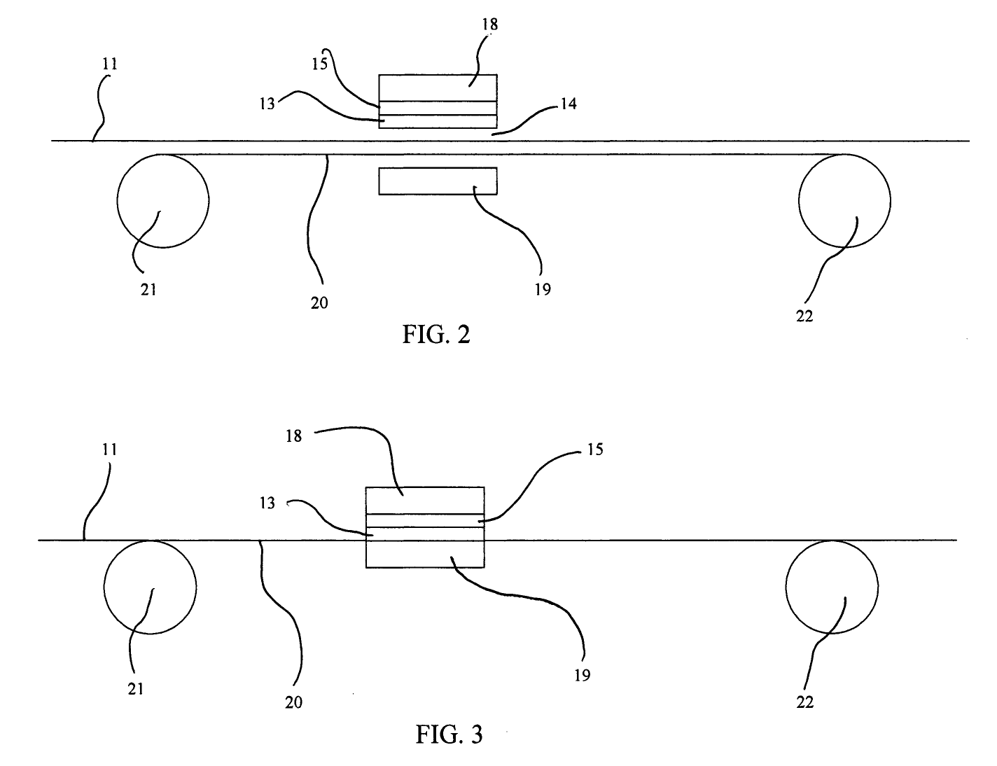

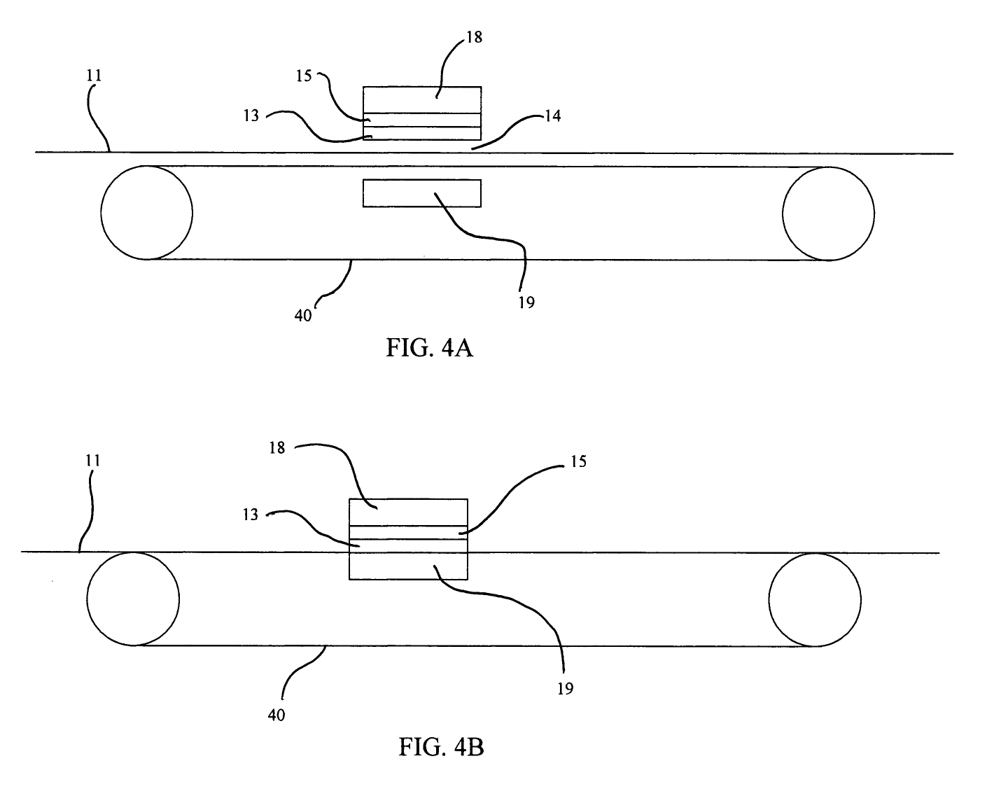

A preferred embodiment of the present invention is illustrated in FIGS. 2 and 3. The carrier 20 may be a carrier support of web material adapted to move from a carrier support pay off roll 21 to a carrier support take up roll 22. The carrier 20 is preferably positioned between the second platen 19 or roller and the process web 11. The carrier 20 preferably provides a thermally and mechanically stable surface to carry the hot embossed web 11 from the embossing zone 14. The process web 11 and the carrier 20 enter the embossing zone 14 and the first platen 18 and/or second platen 19 press together as the stamper 13 embosses the process web 11. To avoid stretching of the microform image, the process web 11 and carrier 20 preferably maintain no movement while the stamper 13 is engaged to the process web 11, as illustrated in FIG. 3. This may be accomplished by intermittently stopping the movement of the process web and carrier during the embossing step. Other systems, such as the use of accumulators to absorb slack as described in U.S. application Ser. No. 10/600,041 filed on Jun. 20, 2003, which is hereby incorporated herein by reference, may be incorporated. The process web is bonded/laminated to the carrier and the hot embossed web and carrier move out of the embossing zone after the stamper disengages from the process web, allowing the hot embossed web to cool away from the embossing zone as a section of unembossed web enters the embossing zone for processing. FIGS. 2 and 3 illustrate an embodiment in which the carrier rolls are adapted to rotate in a clockwise direction, so that the carrier material preferably flows in the same direction and speed as the process web. The process web may be adapted to move from a web pay off roll to a web take up roll. However, the process web rolls may be adapted to rotate in a counter clockwise direction. The process web may tightly engage the carrier down stream from the carrier pay off roll and up stream from the carrier take up roll. To ensure full coverage of the embossing area on the process web, the carrier may be wider than the process web so as to support the entire process web from side to side. Preferably, the process web is bonded/laminated to the carrier simultaneous to the embossing, then the hot embossed web is transferred downstream after stamper separation from the hot embossed web. To prevent damage to the process web, the carrier and process web are preferably set to move at the same rate of speed.

In an alternative embodiment, the carrier may be re-circulating belt 40 of polymeric material. The carrier may be positioned between the second platen 11 and the process web, as illustrated in FIGS. 4A and 4B. The process web 11 tightly engages the carrier up stream from the embossing zone 14 and disengages down stream from the embossing zone 14, after the process web 11 has cooled sufficiently to remove the web 11 without distorting the microform image. The process web 11 and the carrier 40 enter the embossing zone 14 and the first platen 18 and/or second platen 19 press together as the stamper 13 embosses the process web 11. To avoid stretching of the microform image, the process web 11 and carrier 40 preferably maintain no movement while the stamper 13 is engaged to the process web 11. To ensure full coverage of the deposition area on the substrate, the re-circulating belt 40 is preferably wider than the process web 11 so as to support the entire substrate from side to side. Preferably, the process web 11 is bonded/laminated to the carrier 40 simultaneous to the embossing, then the hot embossed web 11 is transferred downstream after stamper 13 separation from the hot embossed web 11. The carrier 40 preferably provides a thermally and mechanically stable surface to carry the hot embossed web 11 from the embossing zone 40. The process web 11 is bonded/laminated to the carrier 40 and the hot embossed web 11 is able to cool away from the embossing zone 14 as a section of unembossed web 11 enters the embossing zone 14 for processing and the process for embossing microstructures begins again. To prevent damage to the process web 11, the re-circulating belt 40 and process web 11 are preferably set to move at the same rate of speed.

In an alternative embodiment, re-circulating carrier segments, rather than a continuous belt of carrier material, are used. The carrier segments provide the same advantages of the carrier belt, but the carrier segments require less carrier material. The platen stamper and second platen are coordinated to engage as a carrier segment positions between the process web and second platen. The process web and the carrier enter the embossing zone and the platen stamper and/or second platen press together as the stamper embosses the process web and bonds/laminates the process web to a segment, simultaneously. To avoid stretching of the microform image, the process web and carrier preferably maintain no movement while the stamper is engaged to the process web. As the stamper embosses the process web in the embossing zone the process web is bonded/laminated to the segment. After the stamper releases contact from the process web, the carrier segment and bonded/laminated hot web move out of the embossing zone and allows the web to cool for the next process step. Sprocket drives, guide rails and the like may be used to maintain alignment of the process web and carrier segment. It should be apparent that sprocket drives, guide rails and the like may be used to maintain alignment of any carrier embodiment that incorporates carrier material moving into and out of the embossing zone.

The carrier may be manufactured from any solid material that may adequately support and adhere to the process web and withstand the conditions of the embossing zone, such as temperature and pressure. Preferably, the carrier has uniform thermal conductivity and stabilizes the process web while the process web is cooling. Preferably, the material is pliable and capable of fabrication into a web that may be formed into a roll of web material. The preferred carrier and support sheet materials include aluminum, alloys such as stainless steel and KOVAR®, polymer/metal laminates, ceramic/metal laminates, polymers such as Kapton® or composites such as carbon/epoxy. The carrier may include a magnetic material to allow for the use of magnetic rollers and/or guides to help stabilize the process web. The thickness of the carrier web is preferably from about 0.05 mm to about 5 mm, depending on its thermal characteristics and the thickness of the process web.

In another embodiment of the present invention, segments of carrier material may be set between the process web and the second platen. The segments of carrier material may be set and removed manually or by means of automated mechanism. The embossed web and carrier may be removed from the embossing zone after the embossing step is complete, i.e. when the stamper has disengaged the process web. The process web and carrier may be set into and removed from the embossing zone using a mechanical arm having, for example, a vacuum or suction cups to transport the process web and carrier without damaging the web or distorting the embossed image.

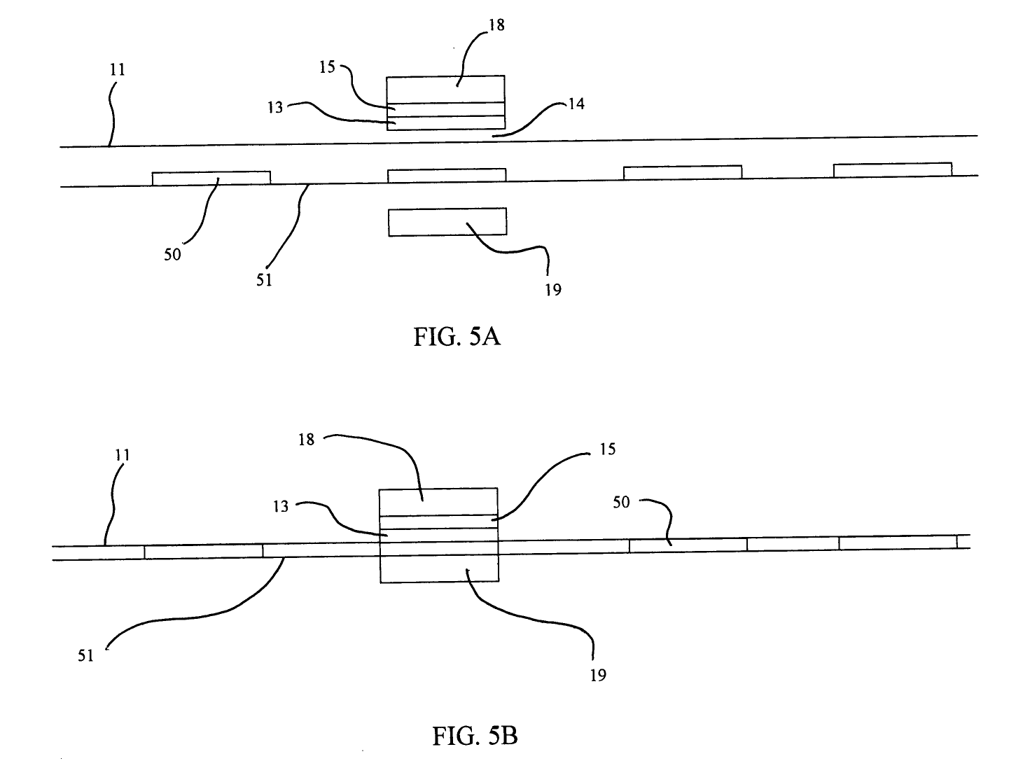

Carrier inserts may be used for process web carriers, as illustrated in FIGS. 5A and 5B. The carrier inserts 50 are designed to facilitate controlled heating and cooling, such that a controlled time-at-temperature profile may be generated at the interface between the polymeric process web 11 and carrier 50, within the polymeric web 11 and at the interface of the stamper(s) 13 and the process web 11. A carrier insert 50 is set into the embossing zone 14 between the second platen 19 and process web 11 and a track 51 moves the carrier inserts 50 through the embossing zone 14. The process web 11 is bonded/laminated to the carrier insert 50 in the embossing zone 14, preferably simultaneous to the embossing. After the stamper 13 disengages from the web 11, the hot embossed web and carrier insert 50 may be transferred from the embossing zone 14 and cooled. Another carrier insert 50 may then be set into the embossing zone 14 between the second platen 19 and another, unembossed section of process web 11. The process web and carrier insert 50 may be set into and removed from the embossing zone 14 using a mechanical arm having, for example, a vacuum or suction cups to transport the process web 11 and carrier insert 50 without damaging the web 11 or distorting the embossed image. In an alternative embodiment, the carrier insert 50 may be set into the embossing zone 14 manually and removed manually after the stamper 13 has separated from the process web 11.

The process may be adapted to utilize an arbitrarily large of carrier inserts, however, the preferable number of carrier inserts depends on the subsequent steps in which the carrier will be used. In an embodiment of the present invention, the carrier insert may be used to stabilize the process web through various vacuum deposition, protective coating, punching and/or trimming sequences, then the process web may be removed from the carrier insert for further processing. In another embodiment, the embossed web is removed from the carrier insert when the bonded/laminated assembly has cooled sufficiently to stabilize the web for handling. After the web is removed, the carrier insert may be recycled to be bonded/laminated to another unembossed section of process web in the embossing zone. In another embodiment, the carrier insert may be part of an assembly that is intended to be a part of a final product formed in part by the carrier insert and embossed web. In this case, the carrier insert remains bonded to the embossed web even after processing. For example, the disclosed process may be used to form an optical memory device wherein the carrier insert is a substrate having microstructure to which the embossed web is bonded.

In one embodiment, the carrier insert(s) may be guided by a track, belt, chain, automated guide-way, or similar type device. The guiding system is used to move the carrier insert(s) between process steps. For example, the guiding system could be used to recycle a carrier insert to the beginning of the process where it would be aligned with and inserted into the opposing platen assembly to begin a replication cycle. Following the embossing replication step the guiding system would allow the embossed web to cool sufficiently then, transport the carrier insert to a vacuum deposition system where at least one layer is deposited on to the exposed surface of the web. Preferably the vacuum deposition system incorporates gas gates to isolate the vacuum deposition system from pressure fluctuation associated with a traditional load-lock system. After the first vacuum deposition, the guiding system would transport the carrier insert to the remaining process stations in proper sequence. Finally, the web is separated from the carrier insert and the guiding system may return the carrier insert to the beginning of the process to begin another replication cycle. However, the embossed web may be removed from the carrier insert at any point in the process after the embossed web has cooled sufficiently and the carrier insert returned to the embossing zone and the guiding system may then return the carrier insert to the beginning of the process to begin another replication cycle.

The platen stamper and second platen are designed to press together with precise alignment accuracy. The platens may further include center inserts that serve as alignment and capturing aids for the carrier inserts.

Opposing components of a punching unit may be incorporated into the platen stamper and second platen in the embossing zone. The punching action is preferably set to occur as the mating sides are pressed together or may be initiated by an external device timed to extend the punch at an appropriate time during the embossing step. As a result, a precisely located hole can be formed. Further, an alignment pin may be set in the second platen, if the hole is created prior to the process web entering the embossing zone. The pin of the second platen aligns the hole of the process web with a hole in the carrier. As the stamper embosses the typical spiral or circular optical memory track structure, and/or other microstructure pattern(s), the pin maintains alignment between the process web and the carrier to which the process web is bonded/laminated. As a result, the holes of the embossed web and carrier remain aligned for further processing, for example where it may be machined, cut, coated, assembled into a multi-layered optical memory structure and/or bonded to a stabilizing backing material.

Selected materials may be applied between the carrier and process web to aid in the bonding/laminating step. The adhesion formed may be temporary or permanent, depending on the intended use of the carrier. For example, if the bonding/laminating process is intended to be temporary a lamination aid with good release characteristics may be used. Examples of temporary lamination aid adhesives include but are not limited to materials such as polystyrene, polyethylene, polypropylene, polyvinyl alcohol, or polyvinyl butyral. For example, if the carrier is intended to be permanent part of the production objective, such as a substrate for an optical disk, a permanent adhesive may be used. Examples of permanent adhesives include but are not limited to thermally cured epoxies and silicones, various polymers with flow and/or melting temperature below the embossing process temperature but higher than anticipated post-embossing temperature (for example “hot-melt adhesives), and thermally cross-linkable polymers.

The embossed web is bonded/laminated to the carrier and transported from the embossing zone as the hot embossed web cools. After the embossed hot web has cooled sufficiently, preferably below Tg, a replica extraction tool may be used to separate the replica from the carrier. While traditional handling methods may be employed, such as annular clamps, vacuum rings, or “suction cup” capturing devices, thin web may be difficult to properly handle in this manner. For this reason, methods that fully stabilize the thin web are preferred. Such methods may require a large contact area that may include the sensitive replicated microstructure. Therefore, the extraction plate preferably has a self-cleaning compliant layer between the extracting plate and the embossed web to protect the embossed image. The extraction mechanism of the removal tool may include mechanical adhesion, chemical adhesion, electrostatic attraction, inter-molecular attraction, alone or in combination. Further, the compliant interface layer may be provided by a semi-fluid or fluid, in this way the risk of contamination and abrasion are reduced. For example, the compliant layer may be comprised of a heat activated coating on the surface of the extraction tool. This coating may be a solid and/or have a high viscosity near room temperature. When heated to a temperature between ambient and process web Tg the material softens, becoming a compliant, semi-fluid, or fluid like substance. Further, the material may be chosen to easily “wet” the surface of the process web while in the softened, semi-fluid, or fluid state. Upon partial cooling the material becomes more viscous and may solidify. In this way it will temporarily bond/laminate to the surface of the process web. Such materials may be selected from a group that includes but is not limited to polystyrene, polyethylene, polypropylene, polyvinyl alcohol, polyvinyl butyral alone or in combination with various plasticizers and release agents, including but not limited to dibutyl phthalate, stearic acid, stearyl alcohol, glycerol monostearate, or pentaerythritol tetrastearate. Materials that undergo a solid/liquid phase change below the glass transition temperature (T_{g}) of the web polymer may be particularly useful as the web capturing compliant interface. Examples include polyethylene, polypropylene, various indium alloys and various wax-like substances. These materials may further contain additives that modify melting temperature, viscosity, wetting, and surface tension. For example, the substance would be heated to its liquid phase before or during contact with the web polymer and allowed to solidify after contact. In this way the replicated surface will adhere to the extractor plate without being damaged. Further, the compliant layer may be provided by high viscosity solutions of substances such as polystyrene, polyethylene, polypropylene, polyvinyl alcohol, polyvinyl butyral nitrocellulose or hydroxypropyl cellulose. Additionally, the compliant layer may be provided by a pressure sensitive adhesive. These and similar materials would facilitate lamination to the web surface.

The stamper is any tool suitable for leaving an impression in web material or optical memory substrate. Also, more than one stamper may be incorporated. The stamper is preferably a disk shaped embossing tool, although in alternative embodiments the stamper could have any shape, such an oblate disk, oval, rectangle, triangle, irregular, etc. The stamper preferably has fine features for producing microstructures in optical memory substrates, such as grooves and/or pits. The fine features may range from greater than several microns to 0.01 microns or less in width, length and depth. The stamper is preferably formed of a rigid material that can be heated to a peak process temperature while maintaining the ability to both form a microstructure on the surface of the web and to easily transfer energy to the interface between the stamper and web of polymeric material upon contact. Representative stamper materials include, nickel, chrome, cobalt, copper, iron, zinc, etc., and various alloys of these metals. The stamper may be composed of a single monolithic material, or of multiple layers of the same material or of different materials. The stamper is preferably comprised of a 0.1 to 1.0 mm thick plate of material, and is more preferably is comprised of an approximately 0.3 mm ±0.1 mm thick plate of material. However, the stamper may also be comprised of multiple layers of different materials, designed to optimize the thermal response of the replication system.

In one embodiment, the stamper(s) may be formed from materials selected to partially or completely absorb specific wavelength bands, including for example low frequency, high frequency, very high frequency, ultra high frequency, microwave, infrared, visible, and/or ultraviolet radiation. Representative structures may include relatively thin absorbing layer(s) formed over a transmitting backing substrate and/or carrier insert. Multiple layers may be employed to optimize heating phase energy absorption and cooling phase heat transfer to the backing material, in this way the embossing time vs. temperature curve may be optimized. The backing substrate and/or carrier insert material may be maintained at a relatively low temperature, for example near T_{g}. In this way a rapid responding, low heat capacity structure(s) may be formed that allows controlled heating and controlled cooling of the stamper/web interface. A similar structure may be formed at the opposing process web carrier and/or process web carrier backing platen to absorb radiation passed by the stamper and web, increasing absorption efficiency and heating uniformity. Additionally, both the stamper platen and process web carrier backing platen assemblies may be used to directly input energy to the system and to provide controlled cooling.

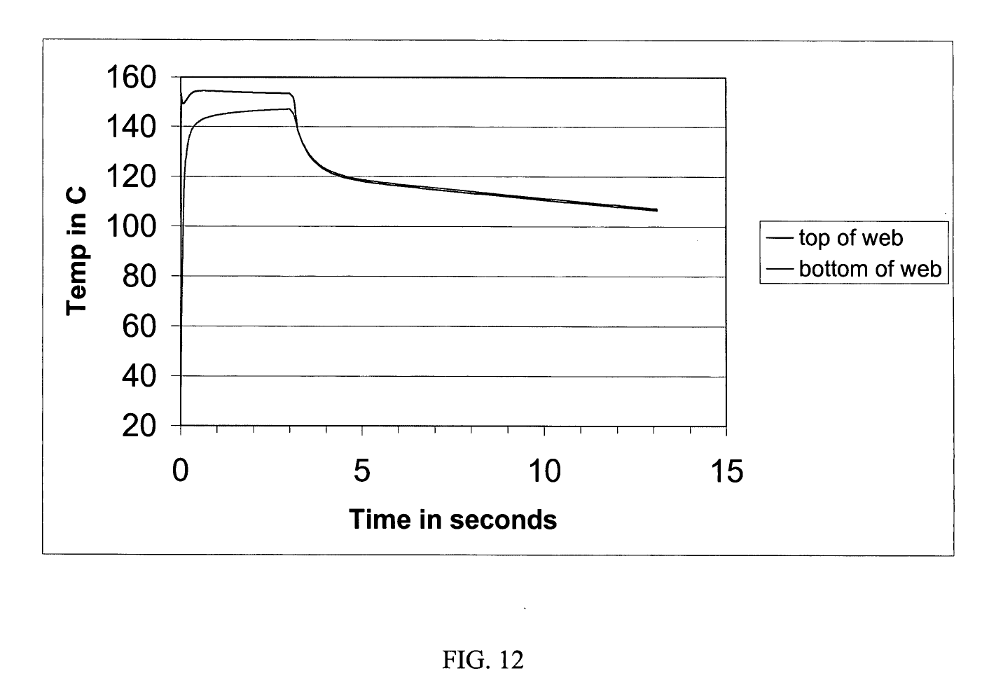

In a preferred embodiment, the cooling of the web is forced convection cooling. Forced convection cooling may be applied to the side of the web opposite the side abutting the carrier to allow uniform cooling throughout the thickness of the web. As illustrated in FIG. 12, forced convection of the appropriate side of the web allows uniform cooling. The temperature of the web is rapidly increased during the embossing step, in this case the stamper contact time is approximately 3 seconds. After separation from the stamper, forced convection cooling allow both sides of the web to cool uniformly with only a slight temperature differential, as illustrated in FIG. 12. This uniform cooling limits web warp that may result from non-uniform cooling.

Appropriate backing materials depend on the frequency of the electromagnetic energy. Selected metal alloys and ceramics may be appropriate for lower frequency operation. Silicon, glass, glass-ceramic, and quartz may be appropriate for higher frequencies, including microwave, infrared, visible and ultraviolet. By utilizing stamper carrier inserts that are transparent to selected wavelengths of energy it becomes possible to independently heat one or both stampers, an interface layer(s) between the backing carrier and stamper(s), and/or treated surfaces on the backing carrier and/or stamper(s). Additionally, by utilizing microstructure carrying surfaces and/or stampers that are transparent or partially transparent to select wavelengths of radiation it becomes possible to independently heat the opposing stamper, the polymeric web, and/or interface layers and/or coatings formed at the stamper polymeric web interface.

In a preferred embodiment hereof, stamper dimensional variation is limited by providing the stamper with a coefficient of thermal expansion (and contraction) substantially matched to the thermal response of the stamper/web interface. Optimized thermal expansion and/or contraction may be provided by any suitable means. For example, optimized thermal expansion and/or contraction may be provided by making the stamper from an alloy, a ceramic, or coating the stamper with a material having a selected coefficient of thermal expansion. For example, a stamper may be made by coating a conventional nickel stamper with another metal, a metal alloy or a ceramic. By selecting materials with matched thermal expansion and/or contraction, a stamper with substantially no measurable relative contraction during web contact can be provided.

Although the apparatus disclosed herein may have wide application in forming web material of all kinds, the web material is preferably a polymeric material of suitable optical, mechanical and thermal properties for making optical memory disks. Preferably, the web material is a thermoplastic polymer, such as polycarbonate, poly methyl methacrylate, polyolefin, polyester, poly vinyl chloride, polysulfone, cellulosic substances, etc. The web material preferably has a refractive index suitable for use in optical memory disks (for example, 1.45 to 1.65). The web thickness is preferably about 0.025 mm to about 1.2 mm, depending upon the intended application. The invention of the current application is particularly useful for embossing a web having a thickness of 600 μm or less, preferably 125 μm or less, most preferably 30 μm to 100 μm. The web is preferably wide enough for replicating one, two, three, four, or more images across the web. The web material may contain one or more additives, such as antioxidants, UV absorbers, UV stabilizers, fluorescent or absorbing dyes, anti-static additives, release agents, fillers, plasticizers, softening agents, surface flow enhancers, etc. The web material is preferably a prefabricated roll formed “off-line”, which may be supplied to the substrate forming apparatus at ambient temperature or may be supplied to the system at ambient temperature. Supplying the web material in the form of a roll to the system at ambient temperature allows for greater flexibility and efficiency.

The stamper may have a domed shape, which is particularly useful when producing a disk for optical recording medium. In the domed stamper embodiment, as the platens press closer together, the stamper first contacts the process web near the center of the circular. This is a result of the slightly domed shape of the stamper. As the platens press even closer together, the mechanism used to impart the domed shape to the stamper is counteracted or overcome, allowing the domed surface to be pushed down against a reference surface or stop. Consequently, the domed shape is progressively reduced as the platens close. Contacting at the center first, and progressively contacting at greater radii as the platens close, prevents the entrapment of air between the web and opposing surfaces. The domed shape may be provided by the direct action of a fixturing mechanism, or as a result of intentional stress and/or temperature imbalance within the process web carrier and/or stamper. Additionally or alternatively, gas entrapment may be reduced by partially evacuating the space between the platens.

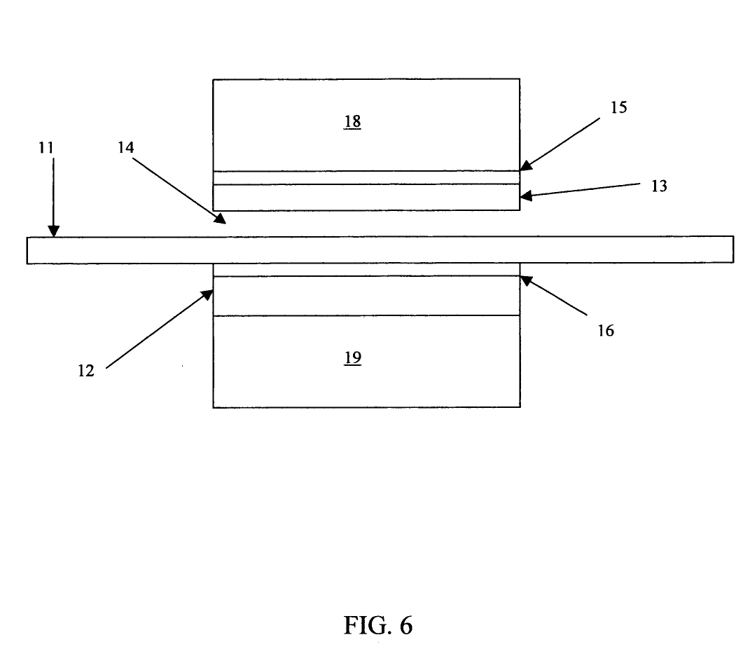

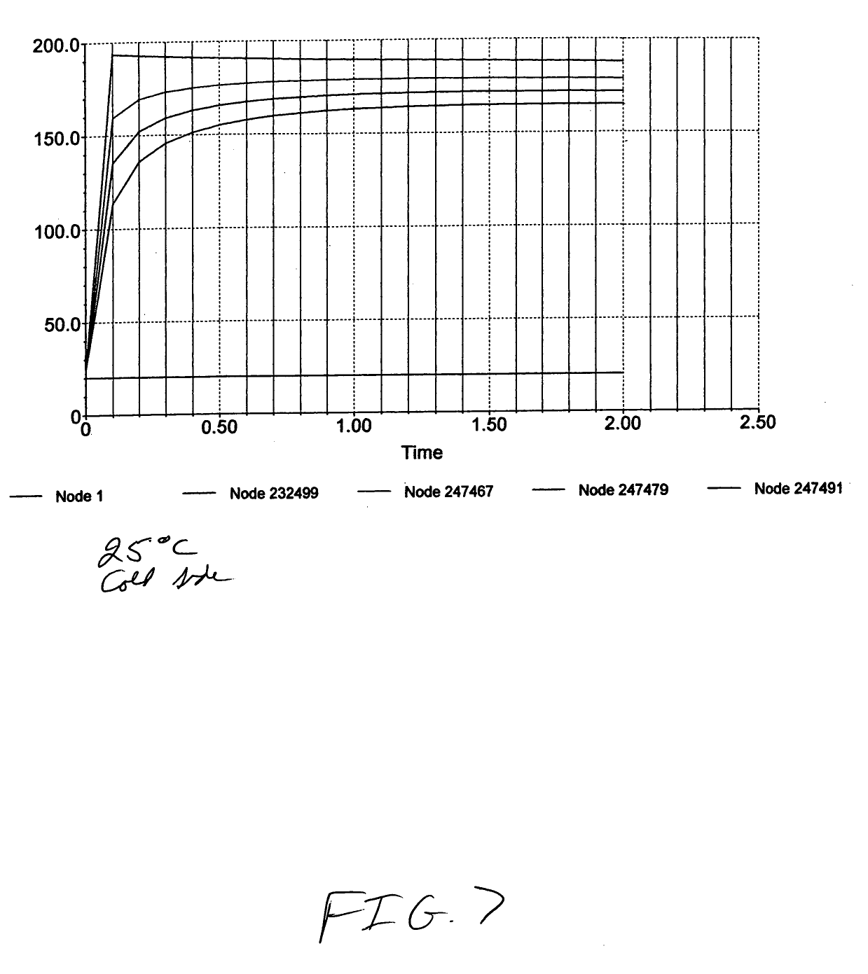

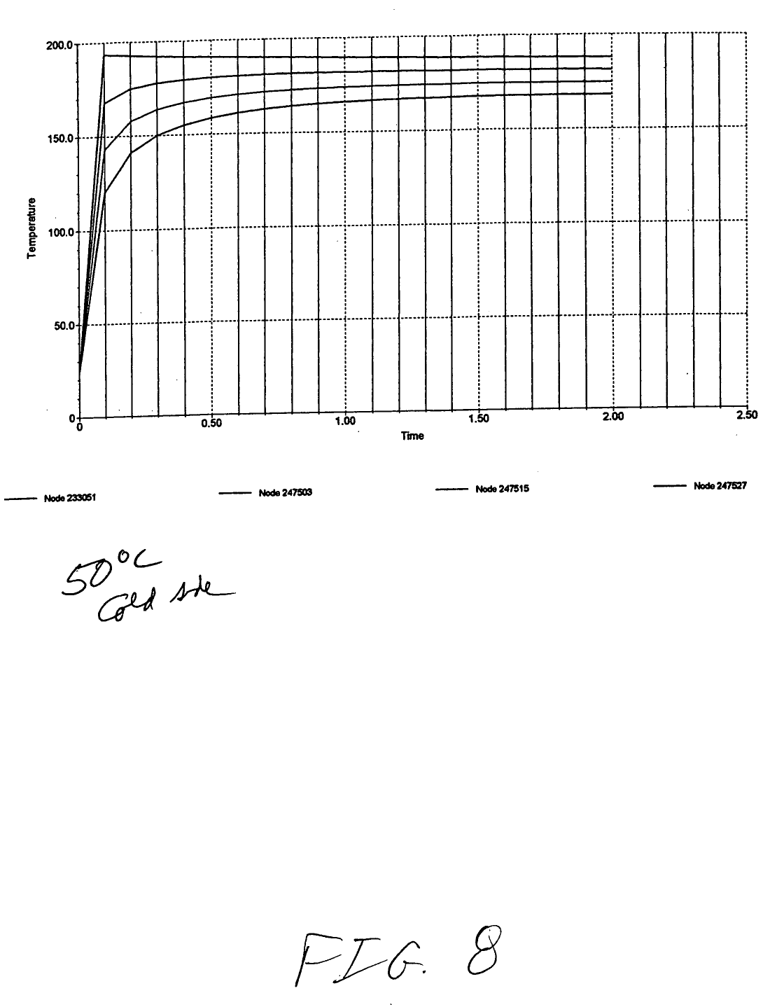

The stamper/stamper platen and process web carrier/carrier backing platen may be heated by any suitable means. For example, one heating method utilizes the stamper, stamper platen and/or carrier backing platen (s) as a plate(s) in a “lossy” capacitor, where a carefully selected insulating material converts an externally applied high frequency field into heat. In a preferred embodiment, the lossy dielectric may include the polymeric web material. Another method heats the stamper, stamper platen and/or carrier backing platen via direct ohmic heating. Another method attaches and/or bonds the stamper and/or carrier backing platen to an ohmic heating element. Another heating method imbeds induction-heating coils within the platens or within stamper and process web carrier inserts. The web and/or process web carrier may be pre-heated before the platens close to start the embossing cycle. Yet another method utilizes carrier inserts that are substantially transparent to electromagnetic energy that may be absorbed by the stamper and/or web. In this case the stamper may also be transparent to a portion of the radiated electromagnetic spectrum. For example, a semi-transparent stamper may absorb infrared radiation and pass ultraviolet radiation that is then absorbed in the polymeric web, generating heat that is localized in the semi-transparent stamper and polymeric web. The radiation source may be imbedded within the temperature controlled base platen assembly(s), the stamper carrier insert(s), or may be provided by an external source. In these ways, heat may be rapidly added before and/or after stamper contacts with the polymeric web. Another preferred method inductively heats the stamper with an external coil that is removed as the platens close. Alternatively, a directed energy source, such as a high power laser, may be used to heat the stamper and/or web immediately prior to and/or after closing the platens. Heating methods may be used alone or in any combination to achieve the desired heating rates while allowing a controlled temperature gradient to be developed in the web. Cooling may be initiated while the platens are still clamped, but the majority of the cooling cycle is envisioned to take place external to the tooling. In this way the clamping cycle time is not extended to accommodate cooling, thereby improving process throughput. Laminating the process web to a stabilizing carrier, prior to or during the embossing process, allows the still hot web to be safely handled before it cools below Tg. Additionally, an insulator 15, such as high temperature rubber or polyimide film, such as KAPTON® film, may be set between the first platen 18 and the stamper 13 to allow an increase in the cooling time, as illustrated in FIG. 6.

The heating methods in which the stamper is heated may be used to heat the second platen as well. Preferably, both the stamper and the second platen are heated to fully anneal the entire cross section of the process web. However, the second platen may be kept at room temperature. Preferably, the second platen provides a bias heat to the process web carrier. By balancing the thermal properties of the carrier with the selected bias heat, the full depth annealing process may continue after the carrier and process web exit the embossing station. process may be that is lower than the temperature of the web-stamper interface, preferably the bias heat is less than Tg of the process web. The ideal temperatures for the stamper and second platen will depend, in part, on Tf and Tg of the process web. For example, polycarbonate typically has a Tg between 140° C. and 150° C. By way of example, process temperatures for the current invention may be 200° C. for the stamper (web-stamper interface) and 100° C. for the second platen when embossing polycarbonate.

In another embodiment hereof, stamper dimensional variation may be reduced by limiting heat loss from the stamper to components of the web forming apparatus or the web or both. Heat loss may be limited in a number of ways including: providing a bias heat to the second platen; insulating the stamper from press components; and reducing the stamper contact time with the process web.

Momentarily raising the stamper/web interface temperature to Tg or above, but below Tf, allows rapid, stress free formation of the web surface to the shape of the microstructures of the stamper. In a preferred embodiment, while the stamper/web interface should be hot enough to enable embossing of the microform image, preferably it should not be so hot that the cross section of the web is melted. However, the web may be heated to a temperature of Tf or above and remain within the spirit and scope of the present invention.

The time/temperature profile may be provided in a number of ways, including balancing stamper peak temperature with stamper thermal properties, adjusting the initial temperature and thermal response of the web, adjusting the initial temperature and thermal response of the stamper/web interface, and/or altering the thermal characteristics of the stamper and second platen that form the embossing zone. Within the contact time, the temperature of the web surface is ramped from near ambient to at or above Tg, but below Tf, and is then cooled to stabilize the image before the stamper separates from the web. Alternatively, the web may be preheated to above ambient, or to even above Tg before contacting the stamper to the web. Preferably the web surface temperature is dropped to Tg or below before the stamper separates from the web. After cooling to below Tg, the embossed web may be removed from the carrier to which the web is bonded/laminated simultaneous to embossing or transferred to other chambers for further processing.

The stamper may be separated from the web at an interface temperature below the melt-flow temperature of the web (e.g. at a temperature less than Tf), preferably below Tg. It should be generally noted that interface cooling rate may be affected by a number of conditions, including: thermal conduction into the web, the thermal characteristics of the web/stamper interface, thermal conductivity of the stamper, thermal conductivity of the second platen, supplying one or more insulating layers, and by active interface temperature control.

Although not desiring to be bound by theory, polymer response to a displacing force involves a viscous component and an elastic component. At Tf the viscous component dominates, and at Tcold (a temperature below Tg) the elastic component dominates. Above Tg (the glass transition temperature) a transition occurs where the increase in free volume allows rotational or translational molecular motion to take place. This freedom allows molecules to move past one another, causing viscous behavior to become more dominant. Embossing polymeric material at Ts or Tsoft (a temperature below Tf but above Tg) requires substantial relaxation of strain before stamper separation. In comparison, the various embodiments of the present invention contemplate embossing the disk substrate at below Tf, and cooling the stamper/web laminate to between Tf and Tg, but not necessarily below Tg, before separation. The optimum temperature points reached in various embodiments of the present invention permit the microstructures in the web to stabilize sufficiently after separation so as to hold their shape, while at the same time avoiding microscopic and macroscopic distortion related to stamper shrinkage. By controlling the time/temperature profile of the stamper/web interface, microstructures on the stamper may be transferred to the web with reduced defects, such as micro-smearing, track shape distortion, and warp. An additional benefit derived from a short time/high temperature thermal profile is a limited thermal penetration depth into the web material. A limited thermal penetration can aid in reducing sub-surface annealing of the polymer, which has been found to be a contributor to total warp. A lowered thermal load can reduce the depth of thermal penetration. While it is possible to reduce average thermal exposure by modifying the shape of the time/temperature profile to achieve extremely high peak temperature at the surface followed by a rapid cooling, this approach may have a practical limit imposed by the instability of certain polymers to excessively high peak temperature.

In operation, the platen stamper engages the second platen. As a result, the web is pressed between the stamper and the carrier, depending on the embodiment. The respective surfaces of the stamper is preferably selected to provide the necessary contact uniformity, to optimize stamp zone dynamic shape and to balance pressure distribution to minimize overall image distortion. Preferred construction materials include, but are not limited to, nitrile, EPDM, Kapton, epoxides, filled epoxides, Teflon, and Teflon infused polymer, metal or ceramic matrixes. It is also appreciated that any material with heat transfer properties suitable for embossing an optical memory microstructure with less than ±0.8 degrees of radial deviation, and less than ±0.3 degrees of tangential deviation may be used.

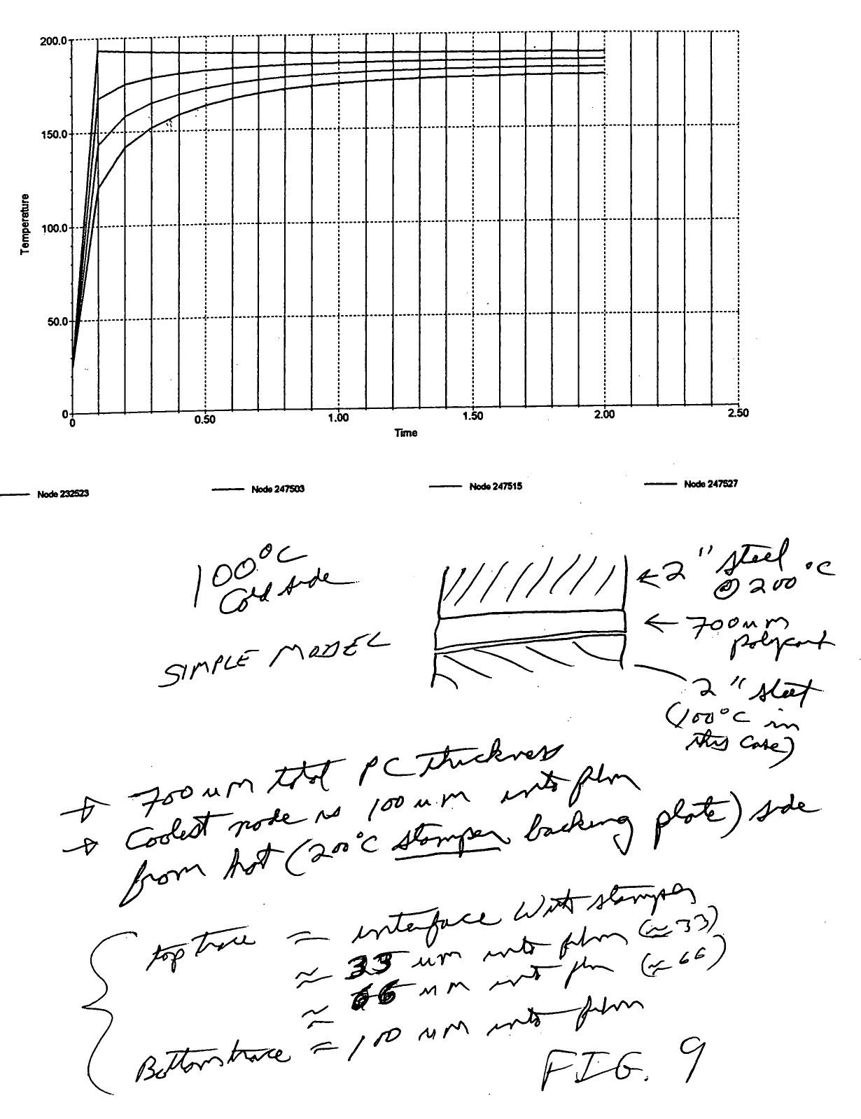

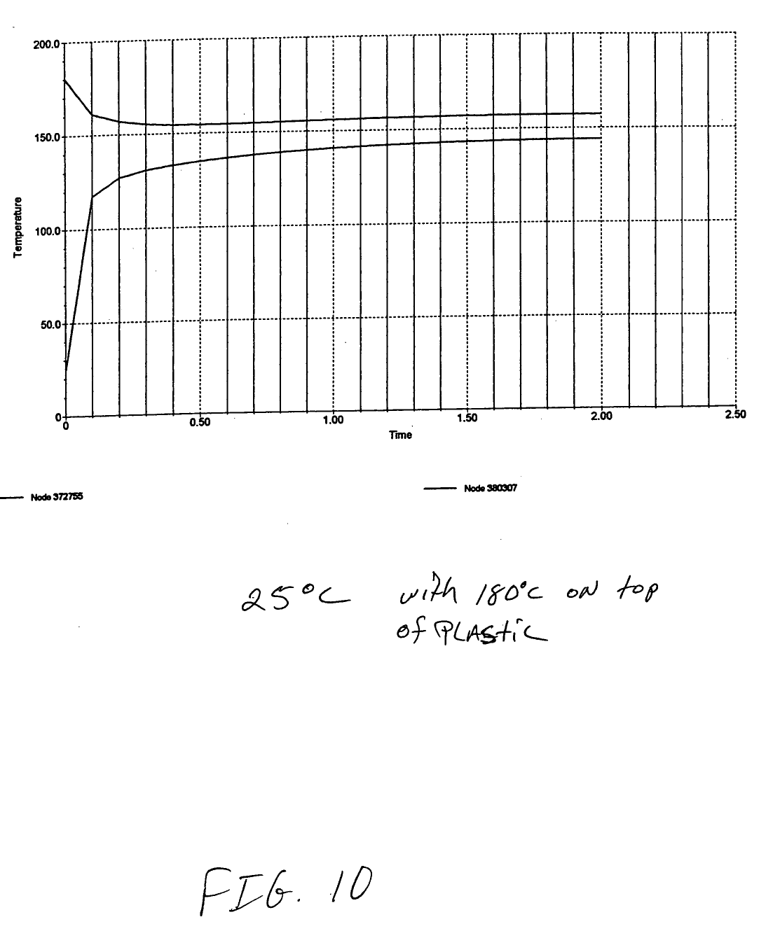

Preferably, the process web is fully annealed throughout the entire thickness of the process web simultaneous to the embossing step. Preferably, a bias heat may be supplied from the second platen. FIGS. 7-9 are graphical illustrations of the process web at varying levels of thickness, wherein the stamper temperature is 200° C. and the embossed material is 700 μm thick polycarbonate. The levels of thickness represent the web/stamper interface temperature (line A), 33 μm from the interface (line B), 66 μm from the interface (line C) and 100 μm from the interface (line D). FIG. 7 is a graphical illustration of varying temperature in the thickness of the web with a bias temperature of approximately 25° C. FIG. 8 is a graphical illustration of varying temperature in the thickness of the web with a bias temperature of approximately 50° C. FIG. 9 is a graphical illustration of varying temperature in the thickness of the web with a bias temperature of approximately 100° C. The graphs show that as the temperature of the opposing platen, i.e. second platen, approaches the temperature of the stamper (˜200° C.) the temperature range of the levels of the thickness of the web narrows. As the bias temperature is applied the space between line A and line D narrows. As a bias temperature is applied the time to achieve full depth annealing of the polycarbonate web is reduced. The peak temperature of the hottest node (line A) may be reduced using an insulating layer between the heat and the web.

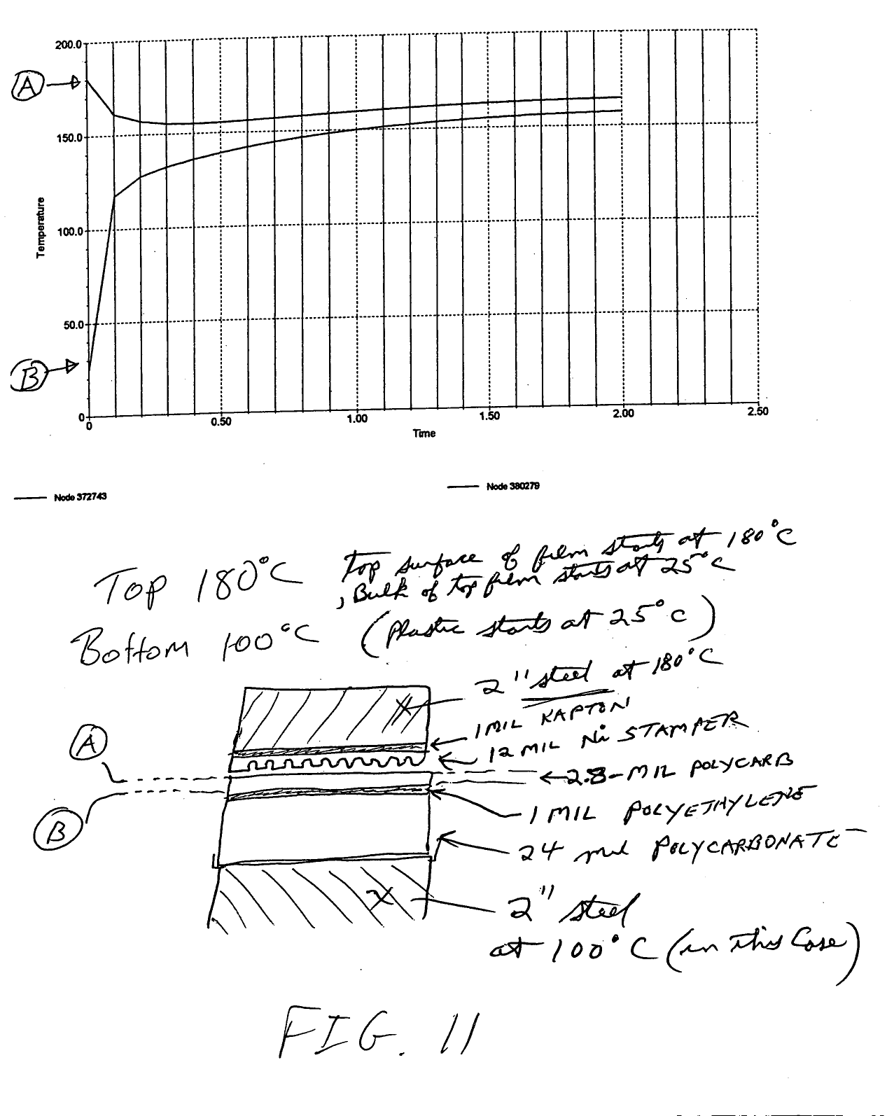

The effect described in the above also occurs when a carrier is set between the second platen and the process web. FIGS. 10 and 11 are graphical illustrations of the temperature of the process web at the web/stamper interface (line A) and the web/carrier interface (line B), wherein the stamper temperature is 180° C. and the embossed material is 1.8 mm thick polycarbonate film. The stamper is a 12 mm thick nickel stamper and a 1 mm thick KAPTON® film is used as an insulating layer between the first platen and the stamper. The carrier in this example is a 24 mm thick polycarbonate film and a 1 mm thick polyethylene film is used to assist the bonding/laminating of the polycarbonate process web to the polycarbonate carrier. FIG. 10 is a graphical illustration of the temperature of the process web at the web/stamper interface and the web/carrier interface with a bias temperature of approximately 25° C. FIG. 11 is a graphical illustration of the temperature of the process web at the web/stamper interface and the web/carrier interface with a bias temperature of 100° C. As the bias temperature is increased the space between line A and line B narrows. As a bias temperature is increased the time to achieve full depth annealing of the polycarbonate web is reduced.

While the invention has been illustrated in detail in the drawings and the foregoing description, the same is to be considered as illustrative and not restrictive in character as the present invention and the concepts herein may be applied to any formable material. It will be apparent to those skilled in the art that variations and modifications of the present invention can be made without departing from the scope or spirit of the invention. For example, the dimensions of the optical substrates, the manner of heating the web in the embossing zone, the means for bonding/laminating the process web to a carrier can be varied without departing from the scope and spirit of the invention. The materials used to construct the various elements used in the embodiments of the invention, such as the stamper, the second platen, the embodiment of the carrier and the heating method, may be varied without departing from the intended scope of the invention. Furthermore, it is appreciated that the support for the platen stamper and the alignment plate could be integrated so as to provide one structure. Still further, it is appreciated that the present invention extends to embodiments that use optical memory substrates in any form, be that web, sheet, or otherwise. Further, by using one or more of the embodiments described above in combination or separately, it is possible to simultaneously emboss a process web, such as a polymeric material with an information track structure, fully anneal the web and bond/laminate the process web to a carrier. Thus, it is intended that the present invention cover all such modifications and variations of the invention, that come within the scope of the appended claims and their equivalents.

1. A process for embossing microstructures on the surface of polymeric material comprising:
providing a web of polymeric material;
adapting the web of polymeric material to move into an embossing zone between a first platen and a second platen, said first platen having a stamper, stamper having a flat surface with at least one microstructure image;
providing a carrier between said web of polymeric film and said second platen heating said web of polymeric material;
adhering the web of polymeric material to said carrier; and
embossing said microstructure image on the web of polymeric material with said stamper in said embossing zone.

2. The process of claim 1, said polymeric material having a glass transition temperature (Tg), wherein heating said web of polymeric material comprises heating said stamper to at least the glass transition temperature (Tg).

3. The process of claim 2, further comprising adapting said web of polymeric material and said carrier to move out of said embossing zone.

4. The process of claim 3, further comprising cooling said web of polymeric material to a temperature below the glass transition temperature (Tg).

5. The process of claim 4, further comprising separating said web of polymeric material from said carrier after said cooling.

6. The process of claim 2, further comprising punching a hole through the web of polymeric material in the embossing zone during said embossing.

7. The process of claim 1, said carrier comprising a carrier support.

8. The process of claim 7, further comprising adapting said carrier support to move into and out of said embossing zone between said web of polymeric material and said second platen, said carrier support comprising a circulating belt of polymeric material.

9. The process of claim 7, further comprising adapting said carrier support material to move into said embossing zone between said web of polymeric material and said second platen, said carrier support moving from a pay off roll and moving to a take up roll.

10. The process of claim 1, said carrier comprising at least one segment of carrier material, said process further comprising setting said at least one segment carrier material between said web of polymeric material and said second platen.

11. The process of claim 1, further comprising applying a heat activated adhesive between said polymeric material and said carrier.

12. The process of claim 1, further comprising applying an insulator layer between said first platen and said stamper.

13. The process of claim 7, said carrier support comprising a re-circulating belt of polymeric material.

14. The process of claim 1, said carrier comprising a carrier insert, said process further comprising setting said carrier insert between said web of polymeric material and said second platen.

15. The process of claim 1, further comprising engaging said stamper with said web of polymeric material.

16. The process of claim 15, said adhering of the web of polymeric material to the carrier and said embossing of said microstructure image on the web of polymeric material in said embossing zone occurring during said engaging.

17. The process of claim 1, said carrier comprising a coated carrier insert removably positioned into said second platen.

18. The process of claim 17, said coated carrier comprising an injection molded polymer carrier having a track microstructure coated with a reflective metal layer, a first dielectric layer, an active recording layer, and a second dielectric layer.

19. The process of claim 18, further comprising bonding said coated polymer material to an optical cover slip.

20. The process of claim 1, wherein said carrier is a heat sink.

21. The process of claim 1, said polymeric material having a thickness, said process further comprising annealing the thickness of said polymeric material simultaneous to said embossing.

22. The process of claim 2, said heating said web of polymeric material further comprising heating said second platen.

23. The process of claim 22, said heating said second platen comprising heating said second platen to less than the glass transition temperature of said polymeric web.

24. The process of claim 1, said web of polymeric material having a thickness of 600 μm or less.

25. The process of claim 1, said carrier having uniform thermal conductivity.

26. The process of claim 15, said engaging comprising a time duration of less than 10 seconds.

27. The process of claim 1, said stamper comprising a flat stamper.

28. The process of claim 1, said stamper comprising a domed stamper.

29. The process of claim 1, said microform image comprising an information track for an optical memory device.
